(19) United States
(12) Patent Application Publication
(10) Pub. No.: US 2020/0125705 A1
(43) Pub. Date: Apr. 23, 2020

(54) USER AUTHENTICATION BASED ON AN ASSOCIATION OF BIOMETRIC INFORMATION WITH A CHARACTER-BASED PASSWORD

(71) Applicant: CA, Inc., New York, NY (US)

(72) Inventors: Mohammed Moiduddin, Bangalore (IN); Shankar Krishnamoorthy, Bangalore (IN)

(21) Appl. No.: 16/165,367

(22) Filed: Oct. 19, 2018

(51) Int. Cl. G06F 21/32

(52) U.S. Cl. CPC G06F 21/32

(57) ABSTRACT

A method includes obtaining a plurality of biometric indicia that are associated with a user, establishing a programmatic association between the plurality of biometric indicia and a plurality of characters, receiving, from the user, a sequence of at least a portion of the plurality of characters, and providing the sequence and the programmatic association to a biometric authentication interface of an electronic device, wherein the biometric authentication interface is configured to authenticate the user responsive to input of ones of the plurality of biometric indicia associated with the at least the portion of the plurality of characters comprising the sequence based on the programmatic association.

### BACKGROUND

The present disclosure relates to electronic devices and systems and, more particularly, to secure access to electronic devices and systems.

Electronic devices and systems can control users' access to many different types of secure programs responsive to security numbers or codes that are entered by the users. Example electronic devices and systems can include mobile phones, tablet computers, laptop computers, building entrances, room entrances, Automatic Teller Machines (ATMs), etc. Example secure programs can include any program which requires the user to correctly enter a personal identification number or other security number or code to obtain access to a protected operation, such as to unlock a user interface, login to a user account, access confidential information, gain entrance to a secure space, etc. Maintaining confidentiality of the security number or code may, therefore, be important. Passwords or security codes may be prone to spying and hacking in public spaces, such when using an ATM, for example. Moreover, the proliferation of mobile electronic devices has increased the likelihood that a user will enter a security number in a public setting where the security number may become compromised by another person. The other person may directly observe numeric digits that the user touch-types on a display of the device or may infer the user's selections based on observing movement of the user's finger relative to a known keypad layout. Some authentication or authorization systems may use biometric information, such as fingerprint information, instead of alphanumeric codes as a security mechanism. Biometric based security systems, however, may also be prone to data leaks and forgery and have less flexibility as they cannot be changed.

### SUMMARY

Some embodiments of the inventive concept are directed to a method comprising obtaining a plurality of biometric indicia that are associated with a user, establishing a programmatic association between the plurality of biometric indicia and a plurality of characters, receiving, from the user, a sequence of at least a portion of the plurality of characters, and providing the sequence and the programmatic association to a biometric authentication interface of an electronic device, wherein the biometric authentication interface is configured to authenticate the user responsive to input of ones of the plurality of biometric indicia associated with the at least the portion of the plurality of characters comprising the sequence based on the programmatic association.

Other embodiments of the inventive concept are directed to a method comprising receiving sequential input, from a user, of ones of a plurality of biometric indicia, determining a sequence of a plurality of characters based on the sequential input of the ones of the plurality of biometric indicia and a programmatic association between the plurality of biometric indicia and the plurality of characters, comparing the sequence with a stored sequence, determining that the sequence matches the stored sequence, and authenticating the user responsive to determining that the sequence matches the stored sequence

Further embodiments of the inventive concept are directed to an electronic device comprising a processor and a memory coupled to the processor and comprising computer readable program code embodied in the memory that is executable by the processor to perform operations comprising: obtaining a plurality of biometric indicia that are associated with a user, establishing a programmatic association between the plurality of biometric indicia and a plurality of characters, receiving, from the user, a sequence of at least a portion of the plurality of characters, and providing the sequence and the programmatic association to a biometric authentication interface of an electronic device, wherein the biometric authentication interface is configured to authenticate the user responsive to input of ones of the plurality of biometric indicia associated with the at least the portion of the plurality of characters comprising the sequence based on the programmatic association.

Other methods, computer program products, systems, and/or electronic devices according to embodiments of the present inventive concept will be or become apparent to one with skill in the art upon review of the following drawings and detailed description. It is intended that all such methods, computer program products, systems, and/or electronic devices be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of an electronic device interface for facilitating user authentication based on an association of biometric information with a character-based password;

FIGS. 2-5 are flowcharts that illustrate operations for associating biometric information with a character-based password in accordance with some embodiments of the inventive concept;

FIGS. 6A, 6B, 6C, and 6D are block diagrams that illustrate the association of biometric information with a character-based password in accordance with some embodiments of the inventive concept; and

FIG. 7 is a block diagram of an electronic device for facilitating user authentication based on an association of biometric information with a character-based password.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

A typical authentication system may rely on biometric information, e.g., fingerprints, retinal scans, and the like, or alphanumeric passwords or codes to authenticate users. Biometric based systems, however, may be prone to data leaks and forgery and lack the flexibility of changing over time as biometric information is permanently associated with a user. Password based systems have greater flexibility in that they can be periodically changed, but are prone to spying and hacking, particularly in public places. Some embodiments of the inventive concept stem from a realization that authentication devices or systems may base biometric based or password based, but not both. Embodiments of the inventive concept may provide an authentication methodology that combines the strength of biometric information with the flexibility of a character-based password, which may make it difficult for a hostile party to gain access to a protected device, system, area, or the like.

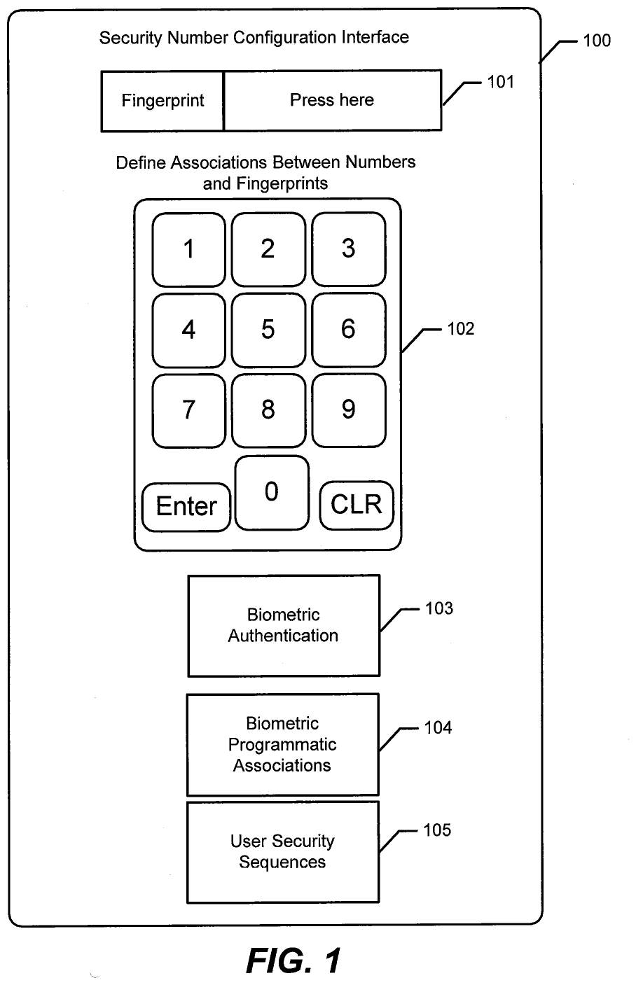

FIG. 1 is a block diagram of an electronic device interface for facilitating user authentication based on an association of biometric information with a character-based password. Referring to FIG. 1, an electronic device or system 100 includes a security number configuration interface including a biometric information capture region 101, a password entry/biometric association region 102, a biometric authentication module 103, a biometric programmatic associations module 104, and a user security sequences module 105. The biometric information capture region 101 may be configured to capture biometric indicia, such as fingerprints, from one or more users. The fingerprints may be obtained using a variety of different ways including using, for example, an optical scanner, a capacitive scanner, or an ultrasonic scanner. Although embodiments of the present inventive concept are described herein with reference to fingerprints being used as a biometric indicium of a user's identity it will be understood that biometric verification includes any means by which a person can be uniquely identified by evaluating one or more distinguishing biological traits. Unique indicia or identifiers may include, but are not limited to, fingerprints, hand geometry, earlobe geometry, retina patterns, iris patterns, voice waves, DNA, and signatures.

The password entry/biometric association region 102 may be a keypad by which a user may programmatically associate biometric indicia, such as the fingerprints obtained through the biometric information capture region 101, with alphanumeric and/or other types of characters. In the example embodiments described herein, the password entry region 102 may be used to programmatically associate numerical digits of a base ten numeral system with fingerprints captured via the biometric information capture region 101. These programmatic associations between the biometric indicia, e.g., fingerprints, and the characters, e.g., the numerical digits, may be stored in a secure location represented as the biometric programmatic associations module 104. One or more users may also interact with the password entry/biometric association region 102 to create one or more password character sequences, e.g., sequences of numerical digits, which may be used to authenticate the user(s). These sequences may be stored in a secure location represented as the user security sequences module 105.

The biometric information capture region 101 may also be used to authenticate a user for access to the electronic device or system 100 or another device, system, secure area, or the like for which the electronic device or system 100 is used to validate the authenticity of users before allowing access or entry. A user may provide biometric indicia in the form of fingerprints, for example, via the biometric information capture region 101. The biometric authentication module 103 may serve as a biometric authentication interface for authenticating a user based on the sequence of fingerprints entered by the user and obtained via the biometric capture region 101, the biometric programmatic associations previously generated by the user, which are stored in the biometric programmatic associations module 104, and the user password or security code or sequence previously generated by the user, which is stored in the user security sequences 105.

In accordance with various embodiments of the inventive concept, the biometric programmatic associations 104 and the user security sequences 105 may be stored locally to the electronic device or system 100 and, thus, the biometric programmatic associations 104 and the user security sequences 105 may be provided to the biometric authentication module 103 in response to requests for the information contained therein. Moreover, the biometric programmatic associations 104 and the user security sequences 105 may be provided to a biometric authentication interface on another device or system for use in controlling access thereto or provided to a common secure storage repository, such as a secure cloud storage location, where multiple devices and systems for which user access is controlled and/or which are used to control access to other devices, systems, areas, and the like may have access to the information contained within the biometric programmatic associations module 104 and the user security sequences module 105.

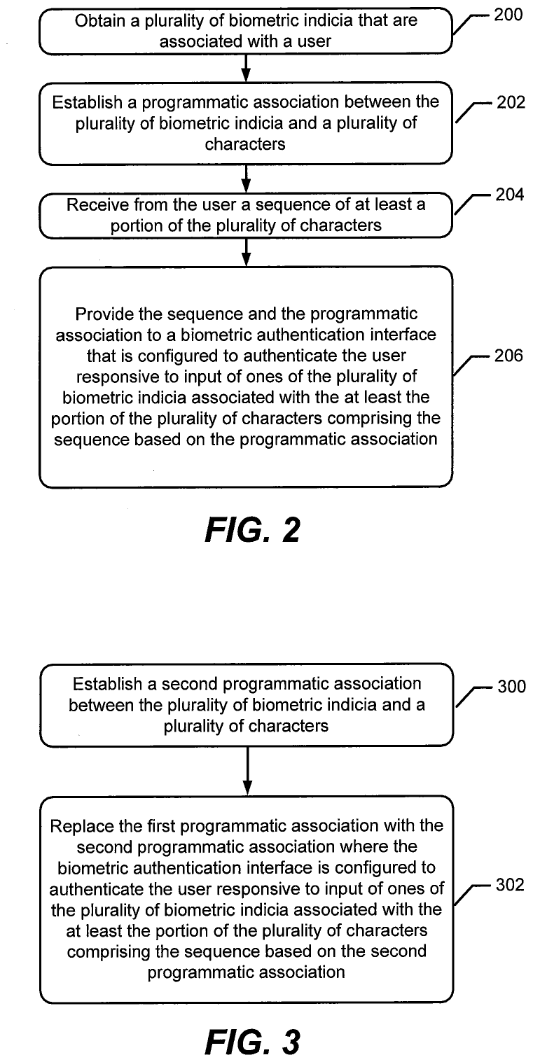

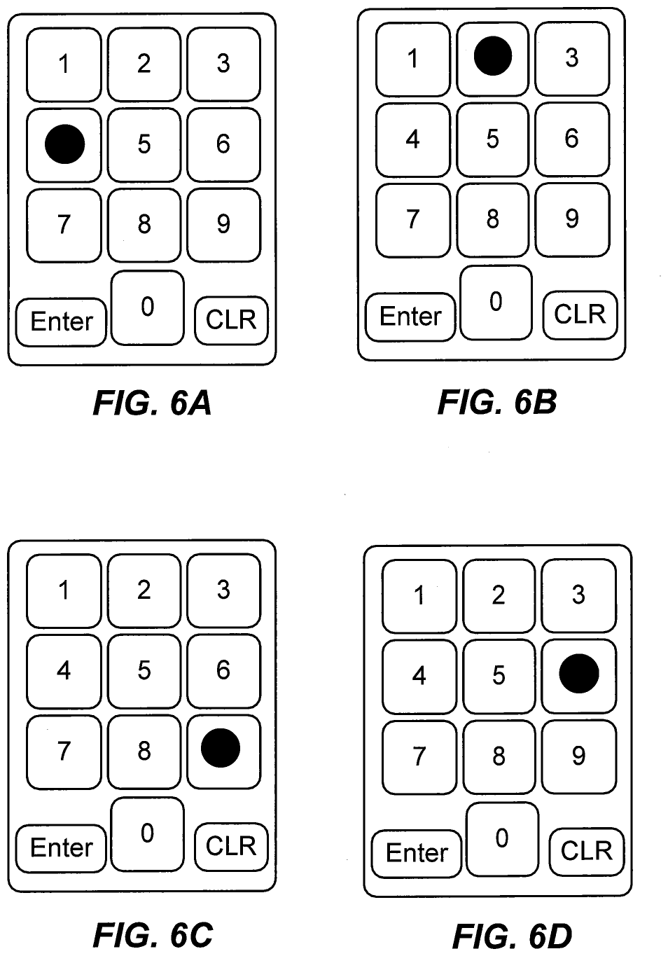

FIGS. 2-5 are flowcharts that illustrate operations for associating biometric information with a character-based password in accordance with some embodiments of the inventive concept. Referring now to FIG. 2, operations begin at block 200 where a plurality of biometric indicia associated with a user are obtained. At block 202, a programmatic association may be established between the plurality of biometric indicia and the plurality of characters. The operations of blocks 200 and 202 may be illustrated by way of example with reference to FIG. 1 and FIGS. 6A-6D. For some of all of a user's fingers, the user may provide a fingerprint via the biometric information capture region 101 and then associate a numerical digit with the fingerprint via the password entry/biometric association region 102, which provides a keypad for associating a numerical digit with each fingerprint. Thus, as shown in FIGS. 6A-6D, a user may provide a fingerprint for the smallest finger on the left hand via the biometric information capture region 101 and then select “4” via the keypad of password entry/biometric association region 102 to associate the number “4” with the fingerprint for the smallest finger on the left hand. Similarly, the fingerprint for the ring finger on the left hand may be associated with the number “2” as shown in FIG. 6B, the fingerprint for the middle finger on the left hand may be associated with the number “9” as shown in FIG. 6C, and the fingerprint of the index finger on the left hand may be associated with the number “6” as shown in FIG. 6D. While programmatic associations between fingerprints and numerical digits are shown for only four fingers on the left hand of a user, it will be understood that similar associations can be made for fewer fingers or more fingers, including all fingers of a user's left and right hands, in accordance with various embodiments of the inventive concept.

Returning to FIG. 2, the user may then provide a sequence of at least a portion of the characters that have been associated with the biometric indicia, e.g., fingerprints, for use as a password at block 204. In the example of FIGS. 6A-6D, the user may enter the sequence “4926” using the keypad of the password entry/biometric association region 102. At block 206, the password sequence obtained from the user at block 204 along with the programmatic association established between the fingerprints and the numerical digits at block 202 are provided to an authentication interface, such as the biometric authentication interface module 103, which is configured to authenticate the user based on the programmatic association in response to the user entering the biometric indicia that corresponds to the user's password sequence. In the example where the user selects “4926” as a password sequence and the user's fingerprints have been associated with numerical digits as described above with respect to FIGS. 6A-6D, the user would provide fingerprints by way of the biometric information capture region 101 in the order of smallest finger on the left hand, middle finger on the left hand, ring finger on the left hand, and index finger on the left hand to be authenticated by the biometric authentication module and granted access to the electronic device 100 or other device, system, protected area, or the like.

Embodiments of the inventive concept may provide a secure user authentication system with flexibility to modify the programmatic associations between the biometric indicia and the characters that may be used, for example, as a password sequence and/or the password sequence itself Referring to FIG. 3, a second programmatic association may be established between the plurality of biometric indicia and a plurality of characters at block 300 using, for example, the operations described above with respect to blocks 200 and 202 of FIG. 2. For example, as shown in FIGS. 6A-6D, instead of solely using the left hand as described above, a user may provide a fingerprint for the smallest finger on the left hand via the biometric information capture region 101 and then select “4” via the keypad of password entry/biometric association region 102 to associate the number “4” with the fingerprint for the smallest finger on the left hand. The user may then switch to the right hand, such that the fingerprint for the ring finger on the right hand may be associated with the number “2” as shown in FIG. 6B, the fingerprint for the middle finger on the right hand may be associated with the number “9” as shown in FIG. 6C, and the fingerprint of the index finger on the right hand may be associated with the number “6” as shown in FIG. 6D. At block 302, first programmatic association between the biometric indicia and the plurality of characters may be replaced with the second programmatic association generated at block 300. The second programmatic association established between the fingerprints and the numerical digits at block 300 may replace an earlier generated programmatic association and may be provided to an authentication interface, such as the biometric authentication interface module 103, which is configured to authenticate the user based on the second programmatic association in response to the user entering the biometric indicia that corresponds to the user's password sequence. In accordance with some embodiments of the inventive concept, at least one association between a fingerprint and a numerical digit differs between the second programmatic association and a previously generated programmatic association that the second programmatic association replaces. In the example where the user selects “4926” as a password sequence and the user's fingerprints have been associated with numerical digits as described above with respect to FIGS. 6A-6D to create a second programmatic association to replace a first programmatic association, the user may provide fingerprints by way of the biometric information capture region 101 in the order of smallest finger on the left hand, middle finger on the right hand, ring finger on the right hand, and index finger on the right hand to be authenticated by the biometric authentication module and granted access to the electronic device 100 or other device, system, protected area, or the like.

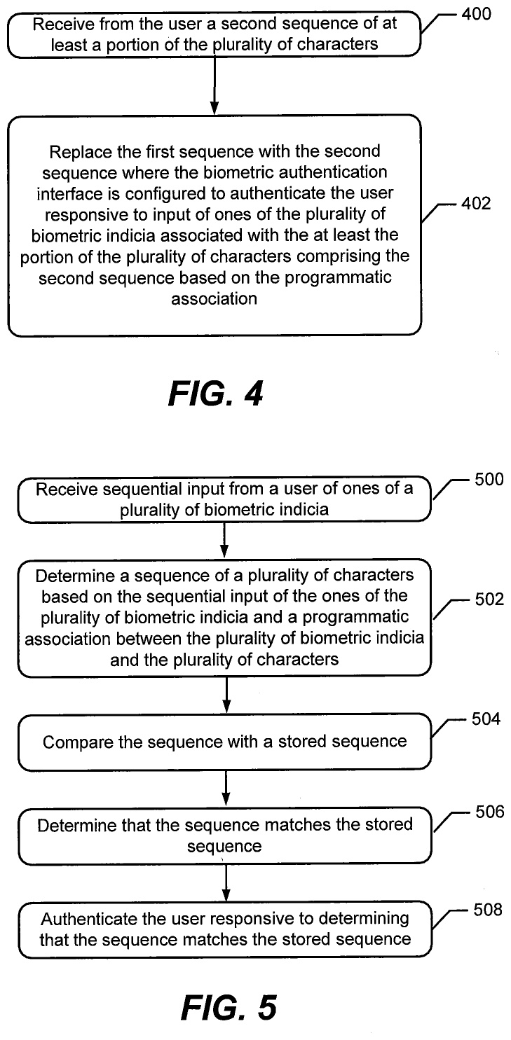

In some embodiments of the inventive concept, the user may provide a new sequence of characters, e.g., numerical digits for use as a new password sequence to replace a previously generated password sequence. Referring to FIG. 4, the user may provide a new or second sequence of at least a portion of the characters that have been associated with biometric indicia, e.g., fingerprints, for use as a new password at block 400. The second sequence received from the user at block 400 may replace an earlier generated sequence and may be provided to an authentication interface at block 402, such as the biometric authentication interface module 103, which is configured to authenticate the user based on a programmatic association in response to the user entering the biometric indicia that corresponds to the user's new password sequence.

Operations for authenticating a user based on an association of biometric information with a character-based password, in accordance with some embodiments of the inventive concept, will now be described with reference to FIG. 5. Operations begin at block 500 where a sequential input of biometric indicia, e.g., a sequential input of fingerprints, are provided through the biometric information capture region 101 of FIG. 1. A character sequence is determined at block 502 based on the biometric indicia that have been input and a previously established programmatic association between the biometric indicia and a plurality of characters, e.g., associations between fingerprints and numerical digits. The determined sequence is compared with a stored password sequence associated with the user at block 504 and a determination is made whether the entered sequence (by way of biometric information) matches the stored password sequence for the user at block 506. The user is authenticated when the entered sequence is determined to match the stored sequence for the user at block 508.

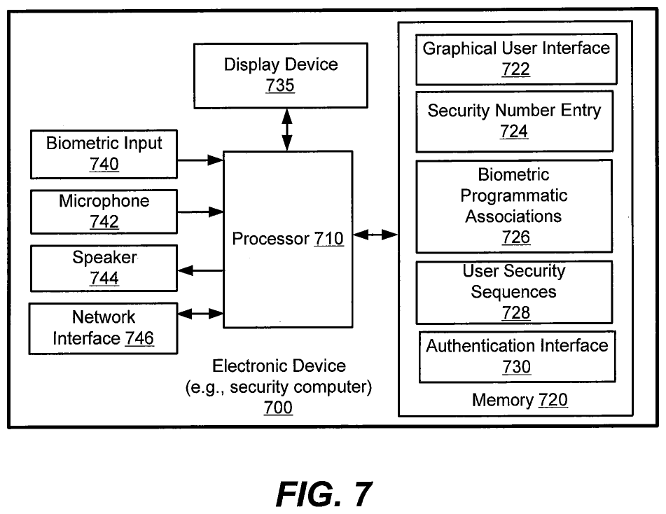

FIG. 7 is a block diagram of an electronic device for facilitating user authentication based on an association of biometric information with a character-based password. Referring to FIG. 7, the electronic device 700 includes a processor 710, a memory 720, and a display device 735. The electronic device 735 may further include a biometric input 740, which may correspond to the biometric information capture region 101 of FIG. 1, a microphone 742, a speaker 744, and a network interface 746 which may include a radio access transceiver and/or a wired network interface (e.g., Ethernet interface).

The processor 710 may include one or more data processing circuits, such as a general purpose and/or special purpose processor (e.g., microprocessor and/or digital signal processor) that may be collocated or distributed across one or more networks. The processor 710 is configured to execute computer readable program code in the memory 720, described below as a non-transitory computer readable medium, to perform at least some of the operations described herein with respect to FIGS. 1-5 and 6A-6D. The program code can include a graphical user interface program 722, which can operate to display images on the display device 730, a security number entry program 724, which may control the password entry/biometric association region 102 of FIG. 1, a biometric programming associations module 726, which may correspond to the biometric programming associations module 104 of FIG. 1, a user security sequences module 728, which may correspond to the user security sequences module 105 of FIG. 1, and an authentication interface module 730, which may correspond to the biometric authentication module 103 of FIG. 1.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
obtaining a plurality of biometric indicia that are associated with a user;
establishing a programmatic association between the plurality of biometric indicia and a plurality of characters;
receiving, from the user, a sequence of at least a portion of the plurality of characters; and
providing the sequence and the programmatic association to a biometric authentication interface of an electronic device, wherein the biometric authentication interface is configured to authenticate the user responsive to input of ones of the plurality of biometric indicia associated with the at least the portion of the plurality of characters comprising the sequence based on the programmatic association.

2. The method of claim 1, wherein the plurality of biometric indicia comprises a plurality of fingerprints;
wherein the plurality of characters comprises a plurality of numerical digits of a base ten numeral system; and
wherein establishing the programmatic association comprises:
establishing the programmatic association between the plurality of fingerprints and the plurality of numerical digits of the base ten numeral system.

3. The method of claim 2, wherein establishing the programmatic association comprises:
establishing the programmatic association such that respective ones of the plurality of fingerprints are associated with unique respective ones of the plurality of numerical digits of the base ten numeral system.

4. The method of claim 2, wherein the programmatic association is a first programmatic association;
wherein establishing the first programmatic association comprises establishing the first programmatic association responsive to first user programmatic input;
wherein the method further comprises:
establishing a second programmatic association between the plurality of fingerprints and the plurality of numerical digits of the base ten numeral system responsive to second user programmatic input; and
replacing the first programmatic association with the second programmatic association, wherein the biometric authentication interface is configured to authenticate the user responsive to input of the ones of the plurality of biometric indicia associated with the at least the portion of the plurality of characters comprising the sequence based on the second programmatic association;
wherein at least one of the plurality of fingerprints is associated with different ones of the plurality of numerical digits in the first programmatic association and the second programmatic association, respectively.

5. The method of claim 2, wherein the sequence is a first sequence of at least a first portion of the plurality of characters;
wherein the method further comprises:
receiving, from the user, a second sequence of at least a second portion of the plurality of characters, wherein at least one of the plurality of characters in the second sequence is not in the first sequence; and
replacing the first sequence with the second sequence, wherein the biometric authentication interface is configured to authenticate the user responsive to input of ones of the plurality of biometric indicia associated with the at least the second portion of the plurality of characters comprising the second sequence based on the programmatic association.

6. The method of claim 1, wherein obtaining the plurality of biometric indicia comprises:
obtaining the plurality of biometric indicia using an optical scanner, a capacitive scanner, or an ultrasonic scanner.

7. The method of claim 1, wherein the electronic device is a first electronic device; and
wherein obtaining the plurality of biometric indicia, establishing the programmatic association, and receiving, from the user, the sequence are performed on the first electronic device.

8. The method of claim 1, wherein the electronic device is a first electronic device;
wherein obtaining the plurality of biometric indicia, establishing the programmatic association, and receiving, from the user, the sequence are performed on a second electronic device; and
wherein the first electronic device is different than the second electronic device.

9. A method comprising:
receiving sequential input, from a user, of ones of a plurality of biometric indicia;
determining a sequence of a plurality of characters based on the sequential input of the ones of the plurality of biometric indicia and a programmatic association between the plurality of biometric indicia and the plurality of characters;
comparing the sequence with a stored sequence;
determining that the sequence matches the stored sequence; and
authenticating the user responsive to determining that the sequence matches the stored sequence.

10. The method of claim 9, wherein the plurality of biometric indicia comprises a plurality of fingerprints; and
wherein the plurality of characters comprises a plurality of numerical digits of a base ten numeral system.

11. The method of claim 10, wherein receiving the sequential input comprises:
receiving sequential input, from the user, of ones of the plurality of fingerprints using an optical scanner, a capacitive scanner, or an ultrasonic scanner.

12. An electronic device, comprising:
a processor; and
a memory coupled to the processor and comprising computer readable program code embodied in the memory that is executable by the processor to perform operations comprising:
obtaining a plurality of biometric indicia that are associated with a user;
establishing a programmatic association between the plurality of biometric indicia and a plurality of characters;
receiving, from the user, a sequence of at least a portion of the plurality of characters; and
providing the sequence and the programmatic association to a biometric authentication interface of an electronic device, wherein the biometric authentication interface is configured to authenticate the user responsive to input of ones of the plurality of biometric indicia associated with the at least the portion of the plurality of characters comprising the sequence based on the programmatic association.

13. The electronic device of claim 12, wherein the plurality of biometric indicia comprises a plurality of fingerprints;
wherein the plurality of characters comprises a plurality of numerical digits of a base ten numeral system; and
wherein establishing the programmatic association comprises:
establishing the programmatic association between the plurality of fingerprints and the plurality of numerical digits of the base ten numeral system.

14. The method of claim 13, wherein establishing the programmatic association comprises:
establishing the programmatic association such that respective ones of the plurality of fingerprints are associated with unique respective ones of the plurality of numerical digits of the base ten numeral system.

15. The electronic device of claim 13, wherein the programmatic association is a first programmatic association;
wherein establishing the first programmatic association comprises establishing the first programmatic association responsive to first user programmatic input;
wherein the operations further comprise:
establishing a second programmatic association between the plurality of fingerprints and the plurality of numerical digits of the base ten numeral system responsive to second user programmatic input; and
replacing the first programmatic association with the second programmatic association, wherein the biometric authentication interface is configured to authenticate the user responsive to input of the ones of the plurality of biometric indicia associated with the at least the portion of the plurality of characters comprising the sequence based on the second programmatic association;
wherein at least one of the plurality of fingerprints is associated with different ones of the plurality of numerical digits in the first programmatic association and the second programmatic association, respectively.

16. The electronic device of claim 13, wherein the sequence is a first sequence of at least a first portion of the plurality of characters;
wherein the operations further comprise:
receiving, from the user, a second sequence of at least a second portion of the plurality of characters, wherein at least one of the plurality of characters in the second sequence is not in the first sequence; and
replacing the first sequence with the second sequence, wherein the biometric authentication interface is configured to authenticate the user responsive to input of ones of the plurality of biometric indicia associated with the at least the second portion of the plurality of characters comprising the second sequence based on the programmatic association.

17. The electronic device of claim 13, wherein the programmatic association is a first programmatic association;
wherein establishing the first programmatic association comprises establishing the first programmatic association responsive to first user programmatic input; and
wherein the sequence is a first sequence of at least a first portion of the plurality of characters;
wherein the operations further comprise:
establishing a second programmatic association between the plurality of fingerprints and the plurality of numerical digits of the base ten numeral system responsive to second user programmatic input;
receiving, from the user, a second sequence of at least a second portion of the plurality of characters, wherein at least one of the plurality of characters in the second sequence is not in the first sequence; and
replacing the first sequence and the first programmatic association with the second sequence and the second programmatic association, respectively, wherein the biometric authentication interface is configured to authenticate the user responsive to input of the ones of the plurality of biometric indicia associated with the at least the portion of the plurality of characters comprising the second sequence based on the second programmatic association;
wherein at least one of the plurality of fingerprints is associated with different ones of the plurality of numerical digits in the first programmatic association and the second programmatic association, respectively.

18. The electronic device of claim 12, wherein obtaining the plurality of biometric indicia comprises:
obtaining the plurality of biometric indicia using an optical scanner, a capacitive scanner, or an ultrasonic scanner.

19. The electronic device of claim 12, wherein the electronic device is a first electronic device; and
wherein obtaining the plurality of biometric indicia, establishing the programmatic association, and receiving, from the user, the sequence are performed on the first electronic device.

20. The electronic device of claim 12, wherein the electronic device is a first electronic device;
wherein obtaining the plurality of biometric indicia, establishing the programmatic association, and receiving, from the user, the sequence are performed on a second electronic device; and
wherein the first electronic device is different than the first electronic device.
